(19) United States
(12) Patent Application Publication
(10) Pub. No.: US 2009/0323560 A1
(43) Pub. Date: Dec. 31, 2009

(54) Customized Media Routing For Conferencing

(75) Inventors: Dalibor Kukoleca, Redmond, WA (US); Kensaku Sueda, Redmond, WA (US); Timothy Mark Moore, Bellevue, WA (US); Neil Anthony Deason, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,732

(22) Filed: Jun. 27, 2008

(51) Int. Cl. H04L 12/16; H04L 12/56

(52) U.S. Cl. 370/261; 370/352

(57) ABSTRACT

Technologies are described herein for customizing media routing for a conference. In one method, a request to modify a routing table is received. The routing table specifies connections between a plurality of sources and a plurality of sinks. The method determines whether the request to modify the routing table is permitted. Upon determining that the request to modify the routing table is permitted, the routing table is modified according to the request.

### BACKGROUND

Audio and video conferencing enables remote participants who are at different locations to participate in a meeting and other collaborative events. In a typical implementation, each conference participant is equipped with a communication device. For example, in an audio conference, each conference participant may have a public switched telephone network (“PSTN”) capable telephone or a voice over Internet Protocol (“VoIP”) capable device. In a video conference, each conference participant may have a computer-based video conferencing system that includes a video camera, a microphone, a display device, and a speaker.

In a basic implementation, a first video conferencing system of a first conference participant captures the video and audio of the first conference participant using the video camera and microphone, respectively. The first video conferencing system then transmits the video and audio across a network to a second video conferencing system of a second conference participant. Upon receiving the video and audio from the first conference participant, the second video conferencing system presents the video on the display device and outputs the audio to the speaker for the second conference participant. In more sophisticated implementations, the video conferencing system may display multiple video feeds from different conference participants in separate windows. An audio conferencing system is similar to the video conferencing system with the exception that video is not captured by a video capture device.

To conduct a conference, a conferencing system typically routes video and/or audio streams from sources (i.e., the conference participants sending the stream) to sinks (i.e., the conference participants receiving the stream). To this end, a conferencing system may provide a routing table that specifies which sinks are connected to which sources. Upon receiving content from various endpoints (e.g., conference participants), the conferencing system may determine which sinks are to receive media content from which sources based on the routing table. For each combination of sources from which a sink is to receive media content, the conferencing system may mix the media content from that combination of sources. The conferencing system then sends the mixed media content to the relevant sinks.

One issue that can arise with conventional routing tables is their inflexibility. In particular, once a routing table has been established for a given conference containing various sources and sinks, streams between these sources and sinks are routed according the routing table. External entities generally do not have the ability to alter the routing table for specific applications. In some implementations, the routing tables may even be hard-coded and unchangeable.

It is with respect to these considerations and others that the disclosure made herein is presented.

### SUMMARY

Technologies are described herein for providing customized media routing for a conference. In particular, a generic and efficient mechanism is provided herein that supports customized routing in a single conference between various sources and sinks. Even after a routing table has been established for a given conference, a trusted external application can utilize the mechanism to alter the routing table as needed to achieve specific results. Further, a conference participant may alter her own entries in the routing table to generate customized media streams.

According to one aspect presented herein, a computer program is provided for customizing media routing in a conference. The computer program receives a request to modify a routing table. The routing table specifies connections between a plurality of sources and a plurality of sinks. The computer program determines whether the request to modify the routing table is permitted. In particular, the request to modify the routing table may be permitted if the request is transmitted from a trusted external application. The request to modify the routing table may also be permitted if the request is transmitted from a conference participant to modify her own routing table entries. Upon determining that the request to modify the routing table is permitted, the computer program modifies the routing table according to the request.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a network architecture configured to provide customized media routing in a conference, in accordance with one embodiment;

FIG. 2A is a diagram showing a routing table prior to customization, in accordance with one embodiment;

FIG. 2B is a diagram showing the routing table of FIG. 2A after customization, in accordance with one embodiment;

FIG. 3 is a flow diagram showing an illustrative method for providing customized media routing in a conference, in accordance with one embodiment; and

FIG. 4 is a computer architecture diagram showing aspects of an illustrative computer hardware architecture for a computing system capable of implementing aspects of the embodiments presented herein.

### DETAILED DESCRIPTION

The following detailed description is directed to technologies for providing customized media (e.g., audio and/or video routing) for a conference. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

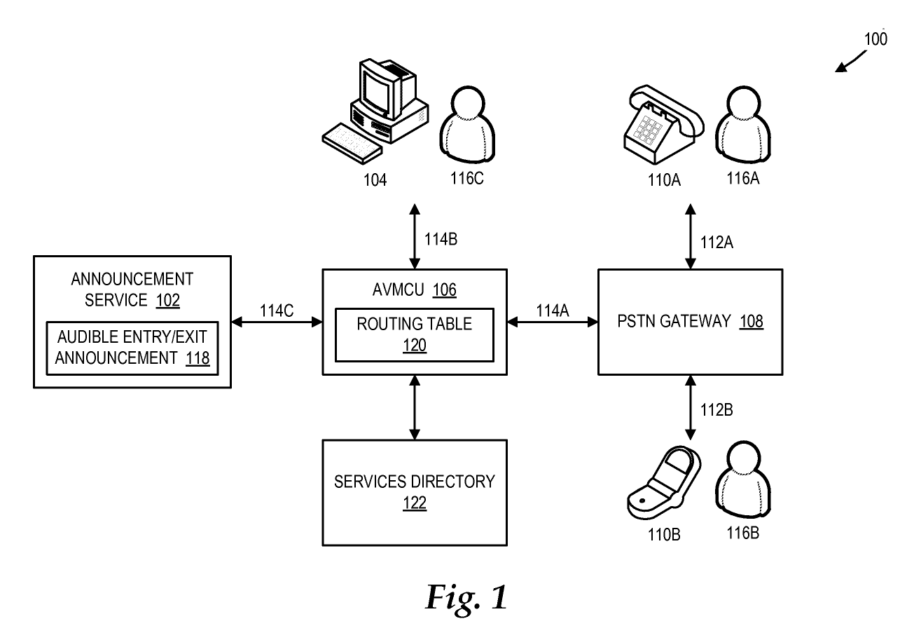

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for customizing media routing for a conference will be described. FIG. 1 illustrates a network architecture 100 operative to enable a trusted service or a conference participant to customize media routing in a conference. In particular, the trusted service or the conference participant can customize media routing by modifying a routing table adapted to connect a plurality of sources and a plurality of sinks. The network architecture 100 illustrates a single conference including a plurality of conference participants.

The network architecture 100 includes an announcement service 102, a VoIP device 104, an audio/video multipoint control unit (“AVMCU”) 106, a PSTN gateway 108, a first PSTN device 110A, and a second PSTN device 110B. The first PSTN device 110A and the second PSTN device 110B (collectively referred to as PSTN devices 110) communicate with the PSTN gateway 108 via PSTN links 112A-112B. Examples of the PSTN devices 110 include a PSTN telephone, a cellular phone, and the like. In one embodiment, the PSTN gateway 108 translates outgoing PSTN communications transmitted across the PSTN links 112A-112B into VoIP communications. The PSTN gateway 108 then transmits the translated VoIP communications across a first VoIP link 114A to the AVMCU 106. The PSTN gateway 108 may also translate incoming VoIP communications into PSTN communications, which can then be audibly heard by a first conference participant 116A and a second conference participant 116B through the PSTN devices 110.

The VoIP device 104 communicates with the AVMCU 106 via a second VoIP link 114B, and the announcement service 102 communicates with the AVMCU 106 via a third VoIP link 114C. Examples of the VoIP device 104 include a VoIP telephone and a computer executing a VoIP application program that enables a user to communicate across a suitable network using a microphone and speakers. A third conference participant 116C may operate the VoIP device 104. In one embodiment, the announcement service 102 provides an audible entry/exit announcement 118 (hereinafter referred to as audible announcement 118) as the conference participants 116A-116C (collectively referred to as conference participants 116) enter and exit a given conference. The audible announcement 118 may be a simple tone or a more complex audio message. For example, the audible announcement 118 may announce the name of the conference participant entering the conference.

In one embodiment, the AVMCU 106 is a conferencing server that administers the conference and supports communications between the conference participants, such as the VoIP device 104 and the PSTN devices 110. In particular, the AVMCU 106 may route communications between conference participants 116 according to a routing table 120. The AVMCU 106 may support, among other media types, instant messaging, web conferencing, audio/visual conferencing, and telephony conferencing. According to embodiments, the AVMCU 106 integrates content in these multiple media types into a single conference stream, which is then provided to conference participants in a seamless manner by utilizing appropriate protocols for each media type. According to further embodiments, the AVMCU 106 may also route communications based on the routing table 120 as modified by trusted sources, such as the announcement service 102, or by conference participants, such as the conference participants 116.

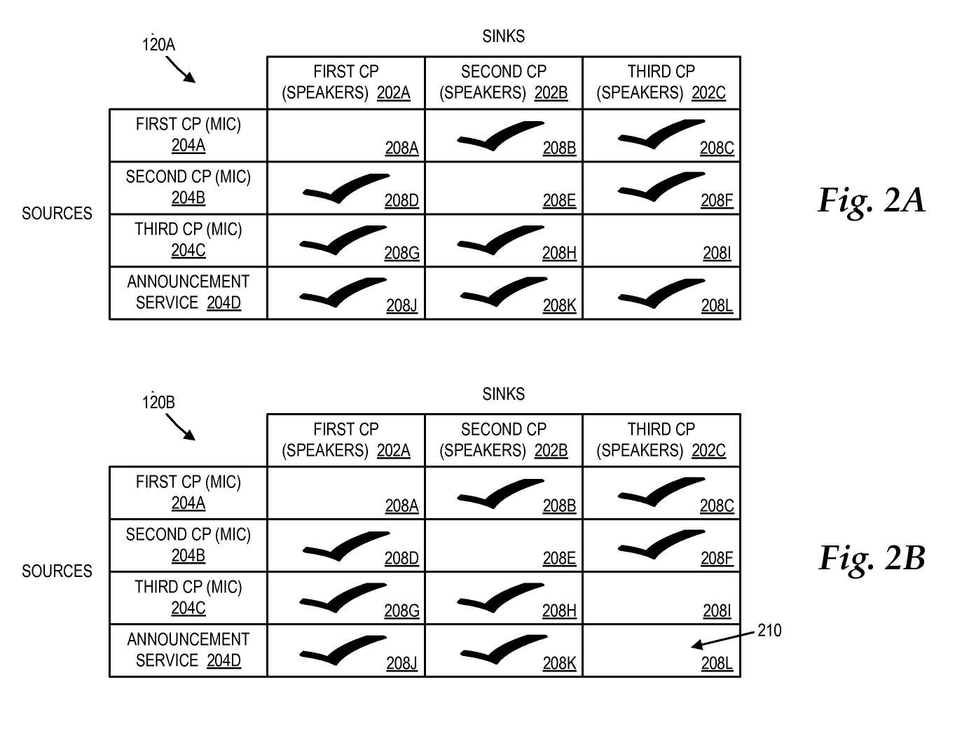

An illustrative implementation of the routing table 120 is illustrated in FIGS. 2A and 2B. In particular, FIG. 2A illustrates the routing table 120A prior to modification by the announcement service 102, while FIG. 2B illustrates the routing table 120B after modification by the announcement service 102. Referring now to FIG. 2A, the routing table 120A includes along an X-axis a plurality of sinks 202A-202C (collectively referred to as sinks 202) and along a Y-axis a plurality of sources 204A-204D (collectively referred to as sources 204). The first sink 202A corresponds to a speaker on the first PSTN device 110A operated by the first conference participant 116A. The second sink 202B corresponds to a speaker on the second PSTN device 110B operated by the second conference participant 116B. The third sink 202C corresponds to a speaker on the VoIP device 104 operated by the third conference participant 116C. The first source 204A corresponds to a microphone on the first PSTN device 110A. The second source 204B corresponds to a microphone on the second PSTN device 110B. The third source 204C corresponds to a microphone on the VoIP device 104. The fourth source 204D corresponds to the announcement service 206. The sinks 202 and the sources 204 may be referred to herein as endpoints.

As illustrated in FIG. 2A, the routing table 120A includes a plurality of entries 208A-208L (collectively referred to as entries 208). Each of the entries 208 corresponds to a given source and given sink. A check mark is displayed in the entries 208A-208L to indicate a connection between a given source and given sink. In particular, the first source 204A is connected with the second sink 202B and the third sink 202C but not the first sink 202A, according to entries 208A-208C. The second source 204B is connected with the first sink 202A and the third sink 202C but not the second sink 202B, according to entries 208D-208F. The third source 204C is connected with the first sink 202A and the second sink 202B but not the third sink 202C, according to entries 208G-208I.

Thus, the routing table 120A specifies that input from the microphone on a given device is routed to the speakers of the other devices in the conference. However, the routing table 120A further specifies that input from the microphone on a given device is not routed to the speakers on the same device. For example, the routing table 120A specifies that input into the microphone on the first PSTN device 110A is routed to the speakers on the second PSTN device 110B and the VoIP device 104. The routing table 200 further specifies that input into the microphone on the first PSTN device 110A is not echoed back to the speakers on the first PSTN device 110A.

Additionally, the fourth source 204D is connected to each of the sinks 202 according to entries 208G-208I. Thus, the routing table 120A specifies that output, such as the audible announcement 118, from the announcement service 102 is routed to the VoIP device 104 and the PSTN devices 110. As previously mentioned, the audible announcement 118 may be played each time a new conference participant enters the conference or an existing conference participant exits the conference.

Referring again to FIG. 1, while configuring the routing table 120 to transmit communications to all of the conference participants 116 may be suitable in many instances, the announcement service 102 may desire a different configuration depending on specific circumstances or to achieve specific results. In particular, the VoIP device 104 may be a computer equipped with a display adapted to show a list of conference participants that is updated in real-time or near-real time as new conference participants enter the conference and existing conference participants exit the conference. In this case, the announcement service 102 may desire not to route the audible announcement 118 to the VoIP device 104 since the audible announcement 118 and the list of conference participants displayed on the VoIP device 104 provide essentially the same notification information. As such, the announcement service 102 may desire to route the audible announcement 118 to only the PSTN devices 110.

The announcement service 102 may transmit a routing modification request to the AVMCU 106. The AVMCU 106 may be configured to accept routing modification requests only from trusted services. This prevents unauthorized services from successfully implementing malicious routing modification requests at the AVMCU 106. In one embodiment, the routing modification request may include a flag specifying that the service transmitting the routing modification request is a trusted service. For example, the flag may only be set by users with administrative privileges associated with the AVMCU 106.

In one embodiment, the routing modification request to the AVMCU 106 requests that communications from the announcement service 102 be routed to only the PSTN devices 110 and not to the VoIP device 104. Referring now to FIG. 2B, the routing table 120B is illustrated after the routing modification request has been accepted and implemented. In particular, at 210, the routing table 120B illustrates a blank space in the entry 208L indicating that communications from the announcement service 102 will not be routed to the VoIP device 104. In contrast, the routing table 120A illustrates a check mark in the entry 208L. As such, the AVMCU 106 has modified the routing table 120A into the routing table 120B in response to the routing modification request from the announcement service 102.

Referring again to FIG. 1, upon receiving and processing the routing modification request from the announcement service 102, the AVMCU 106 may allow the routing modification request and transmit a routing modification acknowledgement notification to the announcement service 102. Once the routing modification request is implemented, the AVMCU 106 may route communications from the announcement service 102 to only the PSTN devices 110 according to the routing table 120B. Alternatively, the AVMCU 106 may deny the routing modification request and transmit a routing modification denial notification to the announcement service 102.

In one embodiment, the announcement service 102 may be included in the conference containing the conference participants 116 in response to one of the conference participants 116 requesting notification by way of the audible announcement 118. For example, when the first conference participant 116A transmits a join request to the AVMCU 106 to join a conference, the first conference participant 116A may select an option to receive the audible announcement 118. Upon determining that the user has selected the option to receive the audible announcement 118, the AVMCU 106 may access a services directory 122 to retrieve an address of record (“AOR”) corresponding to a service associated with the selected option. In one embodiment, the services directory 122 is the ACTIVE DIRECTORY directory service from MICROSOFT CORPORATION. In the example of FIG. 1, the AVMCU 106 may retrieve the AOR corresponding to the announcement service 102 and utilize the AOR to invite the announcement service 102 to join the conference.

It should be appreciated that the announcement service 102 described above with respect to FIG. 1 is merely an illustrative example. Other services that may benefit from customizing the routing table 120 may be similarly utilized. These other services may modify the routing table 120 for a variety of media, including audio and/or video. It should further be appreciated that each of the conference participants 116 may also modify the routing table 120 with respect to her own entries. For example, the first conference participant 116A may desire to receive video streams from a subset of other conference participants. For security purposes, the first conference participant 116A can modify entries 208A-208C, which are associated with the first conference participant 116A, but cannot modify entries 208D-208F, which are associated with the second conference participant 116B.

An illustrative implementation of a routing modification request for modifying the routing table 120 is shown below. The routing modification request may be transmitted from the announcement service 102 to the AVMCU 106. The implementation is shown in extensible markup language (“XML”) but may be similarly expressed in other markup and programming languages.

| | |
|---|---|
| 1. | <request |
| 2. | requestId=″1″ |
| 3. | from=″https://company.com:444/Client″ |
| 4. | to=″https://Mcu55.company.com:444/MCU″ |
| 5. | xmlns=″urn:ietf:params:xml:ns:cccp″ |
| 6. | xmlns:ci=″urn:ietf:params:xml:ns:conference-info″ |
| 7. | xmlns:cis=″urn:ietf:params:xml:ns:conference-info- |
| | separator″> |
| 8. | <modifyEndpointMedia> |
| 9. | <mediaKeys |
| 10. | confEntity=″sip:conf233@example.com″ |
| 11. | userEntity=″sip:cas@example.com″ |
| 12. | endpointEntity=″{A5171205-0D6D-456B-8C03- |
| | A2777D6E1EC4}″ |
| 13. | mediaId=″1″/> |
| 14. | <media id=″1”> |
| 15. | <type>audio</type> |
| 16. | <to-mixer> |
| 17. | <controls> |
| 18. | <route> |
| 19. | <wire userEntity=″sip:foo@contoso.com″ |
| | endpointEntity=″{F38E507D-D8D2-487F-8A6A-5130CB95A7EC}″ |
| | medaId=″1″ /> |
| 20. | <wire userEntity=″sip:bar@fabrikam.com″ |
| | endpointEntity=″{B4DD7359-93D5-4258-AF39-EDD53A5BCEF6}″ |
| | mediaId=″1″ /> |
| 21. | </route> |
| 22. | </controls> |
| 23. | </to-mixer> |
| 24. | </media> |
| 25. | </modifyEndpointMedia> |
| 26. | </request> |

Line one specifies that the above code pertains to a modification routing request. Line three specifies a uniform resource identifier (“URI”) associated with the announcement service 102, which originated the request. Line four specifies the URI associated with the AVMCU 106, which received the request. Line eight specifies the beginning of the modifyEndpointMedia command, which enables the announcement service 102 to customize routing of communications from the announcement service 102.

Customized routing involves specifying a source that transmits a communication and the corresponding sinks that receive the communication from the source. To this end, lines eleven and twelve identify a given source. Lines fourteen and fifteen specify that the media type of the communications from the source is audio. The command “to-mixer” in line sixteen specifies that outgoing communications from the source identified in lines eleven and twelve are routed to sinks identified in lines nineteen and twenty. Line nineteen identifies a first sink, and line twenty identifies a second sink. With respect to lines nineteen and twenty, the command “wire” specifies the sinks to which communications are routed from the source identified at lines eleven and twelve.

An illustrative implementation of a routing modification response indicating whether the routing modification request was accepted by the AVMCU 106 is shown below. In particular, AVMCU 106 may transmit the routing modification response to the announcement service 102. Alternatively, if a conference participant initiated the routing modification request, then the AVMCU 106 may transmit the routing modification response to the conference participant.

| | |
|---|---|
| 1. | <response |
| 2. | requestId=″1″ |
| 3. | to=″https://company.com:444/Client ″ |
| 4. | from=″https://Mcu55.company.com:444/MCU″ |
| 5. | xmlns=″urn:ietf:params:xml:ns:cccp″ |
| 6. | xmlns:ci=″urn:ietf:params:xml:ns:conference-info″ |
| 7. | xmlns:cis=″urn:ietf:params:xml:ns:conference-info- |
| | separator″ |
| 8. | code=″success″> |
| 9. | <modifyEndpointMedia> |
| 10. | <mediaKeys |
| 11. | confEntity=″sip:conf233@example.com″ |
| 12. | userEntity=″sip:cas@example.com″ |
| 13. | endpointEntity=″{A5171205-0D6D-456B-8C03- |
| | A2777D6E1EC4}″ |
| 14. | mediaId=″1″/> |
| 15. | <media id=″1”> |
| 16. | <type>audio</type> |
| 17. | <to-mixer> |
| 18. | <controls> |
| 19. | <route> |
| 20. | <wire userEntity=″sip:foo@contoso.com″ |
| | endpointEntity=″{F38E507D-D8D2-487F-8A6A-5130CB95A7EC}″ |
| | medaId=″1″ /> |
| 21. | <wire userEntity=″sip:bar@fabrikam.com″ |
| | endpointEntity=″{B4DD7359-93D5-4258-AF39-EDD53A5BCEF6}″ |
| | mediaId=″1″ /> |
| 22. | </route> |
| 23. | </controls> |
| 24. | </to-mixer> |
| 25. | </media> |
| 26. | </modifyEndpointMedia> |
| 27. | </response> |

Line one specifies that the above code pertains to a routing modification response. Line eight provides an acknowledgement indicating that the request was successfully accepted. If, on the other hand, the request was not accepted, then line eight may show display another indicator, such as “fail” instead of “success”. The remainder of the routing modification response repeats much of the same code included in the routing modification request that was previously described.

An illustrative implementation of another routing modification request transmitted from the announcement service 102 to the AVMCU 106 is shown below. While the previous routing modification request shown above provides adding new relationships between sources and sinks to the routing table 120, this routing modification request provides for removing relationships between sources and sinks from the routing table 120.

| | |
|---|---|
| 1. | <request |
| 2. | requestId=″2″ |
| 3. | from=″https://company.com:444/Client″ |
| 4. | to=″https://Mcu55.company.com:444/MCU″ |
| 5. | xmlns=″urn:ietf:params:xml:ns:cccp″ |
| 6. | xmlns:ci=″urn:ietf:params:xml:ns:conference-info″ |
| 7. | xmlns:cis=″urn:ietf:params:xml:ns:conference-info- |
| | separator″> |
| 8. | <modifyEndpointMedia> |
| 9. | <mediaKeys |
| 10. | confEntity=″sip:conf233@example.com″ |
| 11. | userEntity=″sip:cas@example.com″ |
| 12. | endpointEntity=″{A5171205-0D6D-456B-8C03- |
| | A2777D6E1EC4}″ |
| 13. | mediaId=″1″/> |
| 14. | <media id=″1”> |
| 15. | <type>audio</type> |
| 16. | <to-mixer> |
| 17. | <controls> |
| 18. | <route> |
| 19. | <unwire userEntity=″sip:foo@contoso.com″ |
| | endpointEntity=″{F38E507D-D8D2-487F-8A6A-5130CB95A7EC}″ |
| | medaId=″1″ /> |
| 20. | </route> |
| 21. | </controls> |
| 22. | </to-mixer> |
| 23. | </media> |
| 24. | </modifyEndpointMedia> |
| 25. | </request> |

Line nineteen identifies a sink that is removed from the modified routing table. With respect to line nineteen, the command “unwire” may remove a sink that was previous added using the “wire” command.

An illustrative implementation of a routing modification request originating from one of the conference participants 116 is shown below. In this routing modification request, a conference participant is requesting to be a sink. That is, a conference participant is requesting that communications from other sources be routed to the conference participant.

| | |
|---|---|
| 1. | <request |
| 2. | requestId=″1″ |
| 3. | from=″https://company.com:444/Client″ |
| 4. | to=″https://Mcu55.company.com:444/MCU″ |
| 5. | xmlns=″urn:ietf:params:xml:ns:cccp″ |
| 6. | xmlns:ci=″urn:ietf:params:xml:ns:conference-info″ |
| 7. | xmlns:cis=″urn:ietf:params:xml:ns:conference-info- |
| | separator″> |
| 8. | <addEndpointMedia> |
| 9. | <mediaKeys |
| 10. | confEntity=″sip:conf233@example.com″ |
| 11. | userEntity=″sip:foo@example.com″ |
| 12. | endpointEntity=″{A5171205-0D6D-456B-8C03- |
| | A2777D6E1EC4}″ |
| 13. | mediaID=″4″/> |
| 14. | <media id=″4”> |
| 15. | <type>video</type> |
| 16. | <label>spotlight-video1</label> |
| 17. | <from-mixer> |
| 18. | <controls> |
| 19. | <route> |
| 20. | <wire userEntity=″sip:foo@contoso.com″ |
| | endpointEntity=″{F38E507D-D8D2-487F-8A6A-5130CB95A7EC}″ |
| | mediaId=″2″ /> |
| 21. | </route> |
| 22. | </controls> |
| 23. | </from-mixer> |
| 24. | </media> |
| 25. | </modifyEndpointMedia> |
| 26. | </request> |

Line eight includes the “addEndpointMedia” command, which generates a media streams from other sources. In this case, lines eleven and twelve identify the originator of the routing modification request as a sink to which communications are routed. Line twenty identifies a source from which the communications are routed. Further, lines fourteen and fifteen specify that the media type of the communications is video. In line seventeen, the command “from-mixer”, in contrast with “to-mixer” described above, specifies that incoming communications from the source identified in line twenty are routed to the sink identified in lines eleven and twelve.

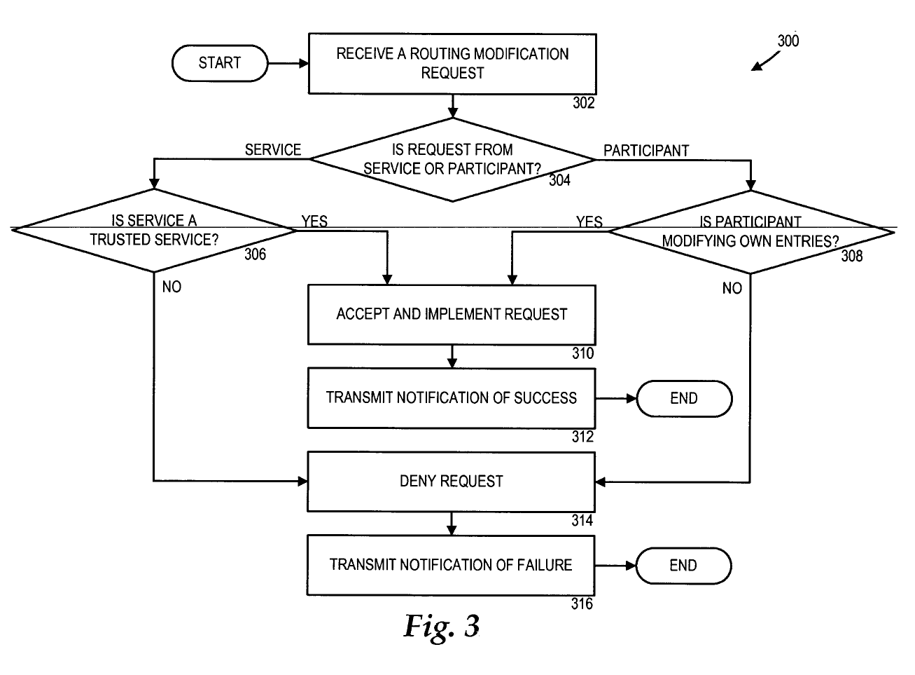

Turning now to FIG. 3, additional details will be provided regarding the operation of the AVMCU 106. In particular, FIG. 3 is a flow diagram illustrating aspects of a method provided herein for customizing media routing in a conference. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 3, a routine 300 begins at operation 302, where the AVMCU 106 receives a routing modification request. The routing modification request may be received from a service, such as the announcement service 102 or from a conference participant, such as one of the conference participants 116. The routine 300 then proceeds to operation 304, where the AVMCU 106 determines whether the routing modification request is transmitted from a service or a conference participant. For example, the routing modification request may include header information indicating what entity originated the request. If the routing modification request is transmitted from a service, then the routine 300 proceeds to operation 306. If the routing modification request is transmitted from a conference participant, then the routine 300 proceeds to operation 308.

At operation 306, the AVMCU 106 determines whether the service that transmitted the routing modification request is a trusted service. For example, a flag in the routing modification request may indicate that the service is a trusted service. If the service is a trusted service, then the routine 300 proceeds to operation 310. If the service is not a trusted service, then the routine 300 proceeds to operation 314.

At operation 310, the AVMCU 106 determines whether the conference participant who transmitted the routing modification request is modifying her own entries in the routing table 120. For security reasons, a conference participant may be prohibited from modifying entries in the routing table 120 that are associated with other users. If the conference participant is modifying her own entries in the routing table 120, then the routine 300 proceeds to operation 310. If the conference participant is not modifying her own entries in the routing table 120, then the routine 300 proceeds to operation 314.

At operation 310, the AVMCU 106 accepts and implements the routing modification request by modifying the routing table 120 according to the routing modification request. For example, the request may specify a new connection between a source and a sink, and the routing table 120 may be modified to include the new connection. Upon accepting the routing modification request, the routine 300 proceeds to operation 312, where the AVMCU 106 transmits, to the originator of the routing modification request (i.e., the service or the conference participant), a routing modification response indicating that the routing modification request is accepted.

At operation 314, the AVMCU denies the routing modification request. Upon denying the routing modification request, the routine 300 proceeds to operation 316, where the AVMCU 106 transmits, to the originator of the routing modification request, a routing modification response indicating that the routing modification is denied.

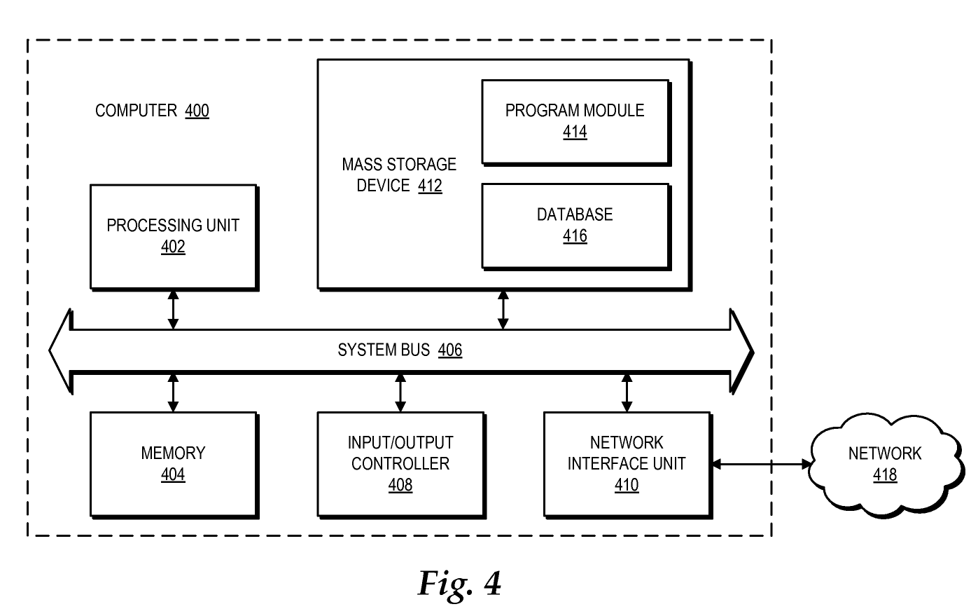

Referring now to FIG. 4, an exemplary computer architecture diagram showing aspects of a computer 400 is illustrated. Examples of the computer 400 may include the announcement service 102, the VoIP device 104, the AVMCU 106, the PSTN gateway 108, and the second PSTN device 110B. The computer 400 includes a processing unit 402 (“CPU”), a system memory 404, and a system bus 406 that couples the memory 404 to the CPU 402. The computer 400 further includes a mass storage device 412 for storing one or more program modules 414 and one or more databases 416. In one embodiment, the program module 414 contains a computer application program adapted to implement at least part of the routine 300 previously described. An example of the databases 416 includes the services directory 122. The mass storage device 412 is connected to the CPU 402 through a mass storage controller (not shown) connected to the bus 406. The mass storage device 412 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available computer storage media that can be accessed by the computer 400.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network 418. The computer 400 may connect to the network 418 through a network interface unit 410 connected to the bus 406. It should be appreciated that the network interface unit 410 may also be utilized to connect to other types of networks and remote computer systems. The computer 400 may also include an input/output controller 408 for receiving and processing input from a number of input devices (not shown), including a keyboard, a mouse, a microphone, and a game controller. Similarly, the input/output controller 408 may provide output to a display or other type of output device (not shown).

Based on the foregoing, it should be appreciated that technologies for providing customized media routing in a conference are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for customizing media routing in a conference, comprising:
receiving a request to modify a routing table, the routing table specifying connections between a plurality of sources and a plurality of sinks;
determining whether the request to modify the routing table is permitted; and
upon determining that the request to modify the routing table is permitted, modifying the routing table according to the request.

2. The method of claim 1, wherein receiving a request to modify a routing table comprises receiving, from a service, the request to modify the routing table.

3. The method of claim 2, wherein determining whether the request to modify the routing table is permitted comprises determining whether the service transmitting the request is a trusted service.

4. The method of claim 3, wherein upon determining that the request to modify the routing table is permitted, modifying the routing table according to the request comprises upon determining that the service transmitting the request is the trusted service, modifying the routing table according to the request.

5. The method of claim 1, wherein receiving a request to modify a routing table comprises receiving, from a conference participant, the request to modify the routing table.

6. The method of claim 5, wherein determining whether the request to modify the routing table is permitted comprises determining whether the request is to modify the conference participant's entries in the routing table.

7. The method of claim 6, wherein upon determining that the request to modify the routing table is permitted, modifying the routing table according to the request comprises upon determining that the request is to modify the conference participant's entries in the routing table, modifying the routing table according to the request.

8. The method of claim 3, wherein the request comprises a source for transmitting a communication and a corresponding sink for receiving the communication transmitted from the source, and wherein modifying the routing table according to the request comprises modifying the routing table to include the source and the corresponding sink specified in the request.

9. The method of claim 8, further comprising:
receiving the communication from the source; and
routing the communication from the source to the corresponding sink based on the modified routing table.

10. A method for customizing media routing in a conference, comprising:
receiving, from a service, a request to modify a routing table, the routing table specifying connections between a plurality of sources and a plurality of sinks;
determining whether the service transmitting the request is a trusted service; and
upon determining that the service transmitting the request is the trusted service, modifying the routing table according to the request.

11. The method of claim 10, further comprising:
receiving a request for the service from a conference participant;
upon receiving the request for the service, retrieving an address of record (AOR) of the service from a services directory; and
transmitting, to the service based on the AOR, an invitation for the service to join the conference.

12. The method of claim 10, wherein receiving, from a service, a request to modify a routing table comprises receiving the request specifying a source for transmitting a communication and a corresponding sink for receiving the communication transmitted from the source.

13. The method of claim 12, wherein the source comprises the trusted service, and wherein the sink comprises a public switch telephone network (PSTN) capable device or a voice over Internet Protocol (VoIP) capable device.

14. The method of claim 12, wherein the source and the sink each comprises a public switch telephone network (PSTN) capable device or a voice over Internet Protocol (VoIP) capable device.

15. The method of claim 12, wherein upon determining that the service transmitting the request is the trusted service, modifying the routing table according to the request comprises upon determining that the service transmitting the request is the trusted service, modifying the routing table to include the source and the corresponding sink specified in the request.

16. The method of claim 15, further comprising:
receiving the communication from the source; and
routing the communication from the source to the corresponding sink based on the modified routing table.

17. The method of claim 10, wherein determining whether the service transmitting the request is a trusted service comprises determining whether the request includes a flag indicating that the request is from the trusted service.

18. The method of claim 10, further comprising:
upon determining that the service transmitting the request is a trusted service, transmitting, to the service, a response indicating that the request is accepted; and
upon determining that the request is not transmitted from the trusted service, transmitting, to the service, a response indicating that the request is denied.

19. A computer-readable storage medium having computer-executable instructions stored thereon which, when executed by a computer, cause the computer to:
receive a request to modify a routing table, the routing table specifying connections between a plurality of sources and a plurality of sinks;
determine whether the request is transmitted from a service or a conference participant;
upon determining that the request is transmitted from the service, determine whether the service transmitting the request is a trusted service;
upon determining that the service transmitting the request is the trusted service, modify the routing table according to the request;
upon determining that the request is transmitted from the conference participant, determine whether the request is to modify the conference participant's entries in the routing table; and
upon determining that the request is to modify the conference participant's entries in the routing table, modify the routing table according to the request.

20. The computer-readable storage medium of claim 19, wherein the request comprises a source for transmitting a communication and a corresponding sink for receiving the communication transmitted from the source.
